(19) United States
(12) Patent Application Publication
(10) Pub. No.: US 2007/0289704 A1
(43) Pub. Date: Dec. 20, 2007

(54) Process for producing circuit board

(75) Inventors: Kenji Takano, Kawasaki (JP); Munekazu Shibata, Kawasaki (JP); Kazuya Arai, Kawasaki (JP); Junichi Kanai, Kawasaki (JP); Kaoru Sugimoto, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/589,103

(22) Filed: Oct. 30, 2006

(30) Foreign Application Priority Data
Jun. 16, 2006 (JP) 2006-166990

(51) Int. Cl. B32B 37/12; B32B 38/04; B32B 37/00; H01B 13/00

(52) U.S. Cl. 156/247; 156/250; 156/267; 216/13; 216/58

(57) ABSTRACT

A process for producing a circuit board includes the steps of detachably laminating a metal foil layer on a surface of a supporting substrate; forming a laminate on the metal foil layer by a buildup method, the laminate including interconnection patterns with insulating layers provided therebetween, the interconnection patterns being electrically connected to each other; separating the metal foil layer from the supporting substrate to detach the laminate; and etching the metal foil layer by photolithography so as to form a predetermined interconnection pattern.

### BACKGROUND OF THE INVENTION

1. Field of the Invention

The present invention relates to a process for producing a circuit board. In particular, the present invention relates to a process for producing a circuit board at low cost.

2. Description of the Related Art

FIGS. 10 and 11 are each a process drawing of an example of a known circuit board (see Japanese Unexamined Patent Application Publication No. 2004-235323).

In FIG. 10A, a supporting substrate 10 includes a copper-clad laminate in which copper foil 11 is bonded on the front surface and the back surface of a resin plate 10a.

Dummy metal layers 41 are bonded to both surfaces of the supporting substrate 10 with adhesive layers 40. Two-layer metal laminates 43, which are larger than the dummy metal layers 41, are bonded to the surfaces of the supporting substrate 10 at peripheries of the dummy metal layers 41 with the adhesive layers 40 so as to cover the dummy metal layers 41 (see FIG. 10B). The two-layer metal laminates 43 each include a copper layer 42; and a metal layer 42a composed of nickel, titanium, or chromium, which is not etched with an etching solution for copper, the metal layer 42a being disposed on the copper layer 42.

As shown in FIG. 10C, a laminate 50 in which interconnection patterns 44 are laminated with insulating layers 46 provided therebetween and are electrically connected to each other using vias 48 is formed on each two-layer metal laminate 43 by a buildup method.

As shown in FIG. 10D, the laminates 50 and the supporting substrate 10 are cut at positions inside the periphery of each dummy metal layer 41 to separate each dummy metal layer 41 from the corresponding two-layer metal laminate 43 to detach the laminates 50.

As shown in FIG. 11A, the copper layer 42 of each two-layer metal laminates 43 is removed by etching using the metal layer 42a as a barrier layer.

As shown in FIG. 11B, the metal layer 42a is removed by etching.

The laminate 50 is inverted (see FIG. 11C). Patterns 52 each composed of a solder resist are formed on the front surface and the back surface of the laminate 50 (FIG. 11D). The exposed interconnection pater 44 is plated with nickel and then gold using the pattern 52 as a mask to form protective plating layers 54 (FIG. 11E). Solder bumps 56 are formed on the predetermined positions to complete the circuit board (FIG. 11F).

### SUMMARY OF THE INVENTION

The above-described known process for producing a circuit board has the following problems: the two-layer metal laminates 43 are ultimately removed by etching. Thus, materials are wasted resulting in an increase in cost and an increase in the number of steps required.

Accordingly, the present invention was accomplished to overcome the problems described above. It is an object of the present invention to provide a process for producing a circuit board at low cost with a small number of steps.

To achieve the object, the present invention provides the following process.

A process according to the present invention for producing a circuit board includes the steps of detachably laminating a metal foil layer on a surface of a supporting substrate; forming a laminate on the metal foil layer by a buildup method, the laminate including interconnection patterns with insulating layers provided therebetween, the interconnection patterns being electrically connected to each other; separating the metal foil layer from the supporting substrate to detach the laminate; and etching the metal foil layer by photolithography so as to form a predetermined interconnection patter.

The process for producing a circuit board described above further includes the steps of bonding a dummy metal layer to a surface of the supporting substrate with an adhesive layer; bonding the metal foil layer with the adhesive layer so as to cover the dummy metal layer with the metal foil layer, the metal foil layer being larger than the dummy metal layer; and cutting the laminate and the supporting substrate at inner positions compared with the periphery of the dummy metal layer and separating the metal foil layer from the dummy metal layer to detach the laminate.

A process according to the present invention for producing a circuit board includes the steps of detachably laminating metal foil layers on the front surface and back surface of a supporting substrate; forming a laminate on each metal foil layer by a buildup method, each laminate including interconnection patterns with insulating layers provided therebetween, the interconnection patterns being electrically connected to each other; separating the metal foil layers from the supporting substrate to detach the laminates; and etching each metal foil layer by photolithography so as to form a predetermined interconnection pattern.

The process for producing a circuit board described above further includes the steps of bonding dummy metal layers to the front and back surfaces of the supporting substrate with adhesive layers; bonding metal foil layers on the surfaces of the supporting substrate at the peripheries of the dummy metal layers with the adhesive layers so as to cover the dummy metal layers with the metal foil layers, each metal foil layer being larger than the corresponding dummy metal layer; and cutting the laminates and the supporting substrate at positions inside the peripheries of the dummy metal layers and separating the metal foil layers from the dummy metal layers to detach the laminate from the supporting substrate.

According to the present invention, the metal foil layer detachably laminated on the supporting substrate is not removed by etching but used as one of the interconnection patterns of the laminate after processing, thus reducing the number of steps and not causing waste. Furthermore, the circuit board is formed on the supporting substrate and then detached from the supporting substrate, thereby efficiently producing as thin circuit board with high-density interconnections.

### BRIEF DESCRIPTION OF THE DRAWINGS

FIG. 1 illustrates a state in which a metal foil is laminated on each surface of a supporting substrate;

FIG. 2 illustrates an example of a structure in which metal foil layers are detachably laminated on a supporting substrate;

FIG. 3 illustrates a state in which a multilayer interconnection pattern is formed by means of a buildup method on each metal foil layer shown in FIG. 2;

FIG. 4 illustrates a state in which laminates formed in a step shown in FIG. 3 are detached from the supporting substrate;

FIG. 5 illustrates a state in which a resist pattern is formed on the metal foil layer on the laminate;

FIG. 6 illustrates a state in which the metal foil layer is etched using the resist pattern as a mask to form an interconnection pattern;

FIG. 7 illustrates a state in which a solder resist pattern is formed on the laminate;

FIG. 8 illustrates a state in which protective plating films are formed on the exposed interconnection pattern;

FIG. 9 illustrates a state in which solder bumps are formed on the exposed interconnection pattern to complete a circuit board;

FIGS. 10A to 10D illustrate first four steps in a known method for producing a circuit board; and

FIGS. 11A to 11F illustrate last six steps in the known method for producing the circuit board.

### DESCRIPTION OF THE PREFERRED EMBODIMENTS

Preferred embodiments of the present invention will be described in detail with reference to the drawings.

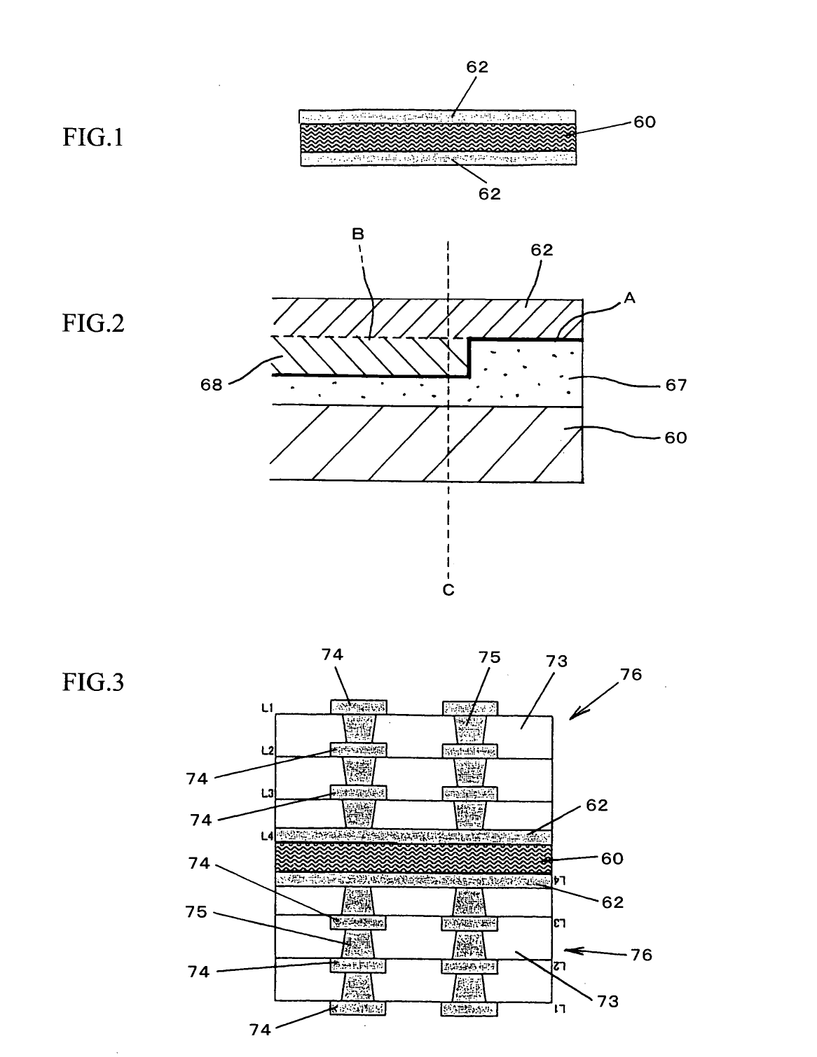

FIGS. 1 to 9 each illustrate a process for producing a circuit board according to the present invention.

As shown in FIG. 1, metal foil layers 62 are detachably laminated on the front surface and the back surface of a supporting substrate 60.

The metal foil layers 62 are each composed of copper foil and each have a thickness of about 18 to 7 μm.

The supporting substrate 60 is composed of a material having sufficient stiffness so as to have good handleability in forming work (laminate) including formation of an insulating layer, a plating layer, and the like, and in transportation thereof, and having sufficient strength to prevent deformation, such as shrinkage and warpage, of the work. In this embodiment, the supporting substrate 60 is an epoxy resin substrate having a thickness of 0.3 to 0.4 mm and containing a glass cloth. The supporting substrate 60 may be formed of only a resin substrate such as the epoxy resin substrate containing a glass cloth or may be formed of only a metal plate, as long as a predetermined strength is ensured.

A structure shown in FIG. 2 is preferred in order to detachably laminate each metal foil layers 62 on the supporting substrate 60.

That is, dummy metal layers 68 are bonded to the front surface and the back surface of the supporting substrate 60 with adhesive layers 67. Each metal foil layer 62 that is larger than the corresponding dummy metal layer 68 is bonded on a surface of the supporting substrate at the periphery of the metal foil layer 62 with an adhesive layer 67 to cover the dummy metal layer 68.

A thick line A shown in FIG. 2 indicates a portion in which the dummy metal layer 68 and the metal foil layer 62 are bonded to the adhesive layer 67. Furthermore, a dashed line B indicates a portion in which the metal foil layer 62 is only in contact with the dummy metal layer 68. Thus, it is possible to detach the metal foil layer 62 from the dummy metal layer 68 by cutting the metal foil layer 62, the dummy metal layer 68, and the supporting substrate 60 along a line C that is located at a position inside the periphery of the dummy metal layer 68. To prevent the inclusion of air at the portion indicated by the dashed line B, these lamination step are preferably performed using a vacuum apparatus.

As shown in FIG. 3, a laminate 76 in which interconnection patterns 74 are laminated with insulating layers 73 provided therebetween and are electrically connected to each other using vias 75 is formed on each metal foil layer 62.

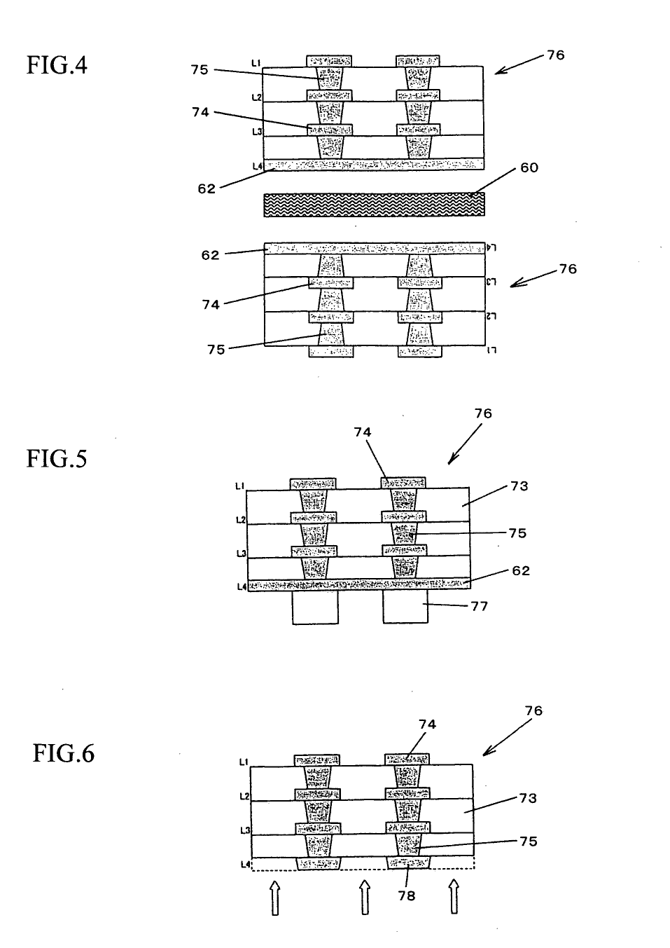

Next, the resulting laminates are cut along line C shown in FIG. 2 to detach the laminates 76 from the supporting substrate 60 as shown in FIG. 4.

As shown in FIG. 5, the metal foil layer 62 on the resulting laminate 76 is processed by a series of photolithographic steps, for example, by forming a resist pattern 77, etching the metal foil layer 62 using the resist pattern 77 as a mask, and removing the resist pattern 77, thereby forming an interconnection pattern 78.

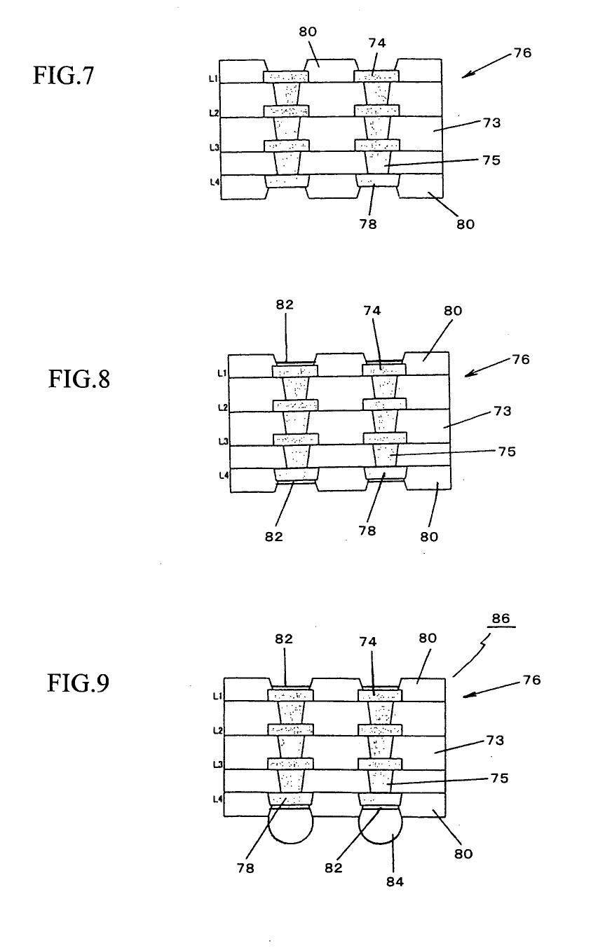

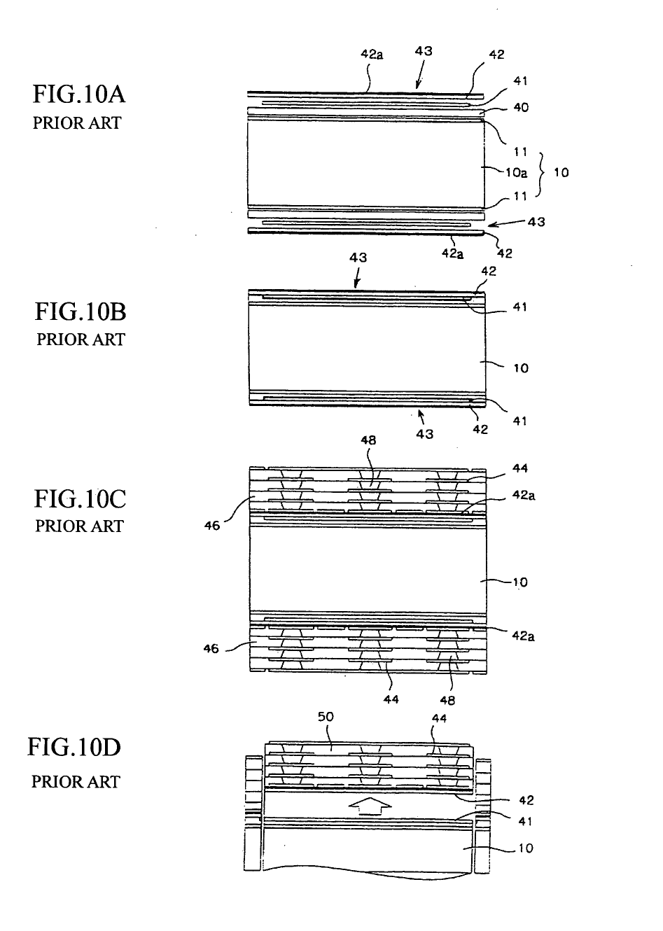

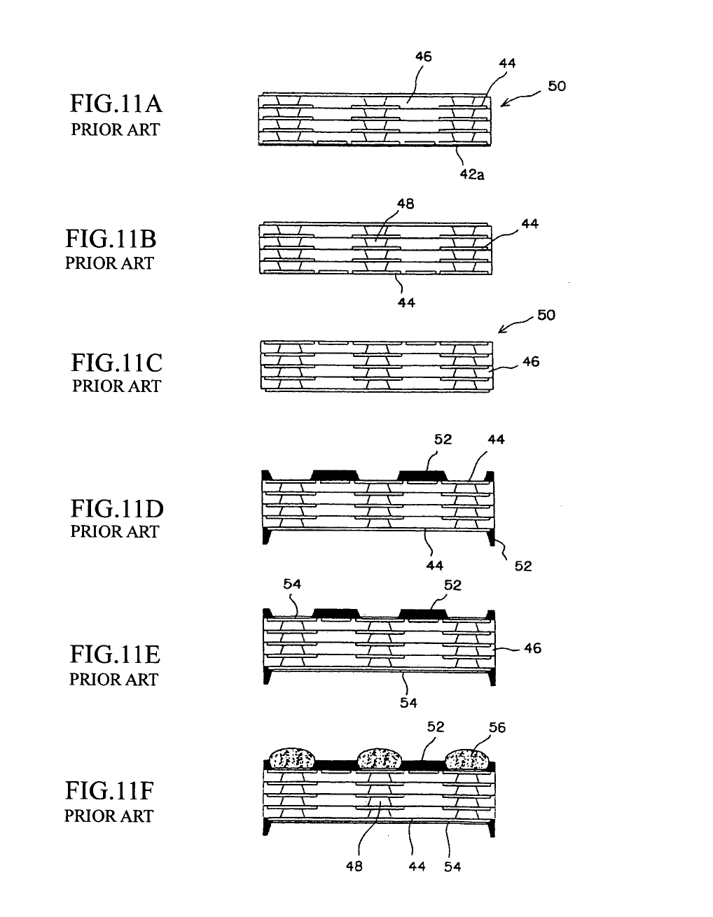

As shown in FIG. 7, solder resist layers 80 are formed on the front and back surfaces of the laminate 76 in such a manner that predetermined portions of interconnection patterns 74 and 78 disposed at the front and back surfaces of the laminate 76 are exposed. As shown in FIG. 8, the exposed portions of interconnection patterns 74 and 78 are plated with nickel and then gold to form protective plating films 82. Furthermore, solder bumps 84 for connection with the exterior are formed on the predetermined portions of the interconnection pattern 78 to complete a circuit board 86.

With respect to the circuit board 86, generally, a plurality of circuit boards are integrally formed. Then, the resulting integrated boards are separated into target circuit boards.

In the above-described embodiment, the laminates 76 are formed on the front surface and the back surface of the supporting substrate 60. However, the laminate 76 may be formed on only one surface of the supporting substrate 60.

What is claimed is:

1. A process for producing a circuit board, comprising the steps of:
detachably laminating a metal foil layer on a surface of a supporting substrate;
forming a laminate on the metal foil layer by a buildup method, the laminate including interconnection patterns with insulating layers provided therebetween, the interconnection patterns being electrically connected to each other;
separating the metal foil layer from the supporting substrate to detach the laminate; and
etching the metal foil layer by photolithography so as to form a predetermined interconnection pattern.

2. The process for producing a circuit board according to claim 1, further comprising the steps of:
bonding a dummy metal layer to a surface of the supporting substrate with an adhesive layer;
bonding the metal foil layer to the surface of the supporting substrate at the periphery of the metal foil layer with the adhesive layer so as to cover the dummy metal layer with the metal foil layer, the metal foil layer being larger than the dummy metal layer; and
cutting the laminate and the supporting substrate at inner positions compared with the periphery of the dummy metal layer and separating the metal foil layer from the dummy metal layer to detach the laminate.

3. A process for producing a circuit board, comprising the steps of:
detachably laminating metal foil layers on the front surface and back surface of a supporting substrate;
forming a laminate on the metal foil layer by a buildup method, the laminate including interconnection patterns with insulating layers provided therebetween, the interconnection patterns being electrically connected to each other;
separating the metal foil layer from the supporting substrate to detach the laminate; and
etching each metal foil layer by photolithography so as to form a predetermined interconnection pattern.

4. The process for producing a circuit board according to claim 3, further comprising the steps of:
bonding dummy metal layers to the front and back surfaces of the supporting substrate with an adhesive layer;
bonding metal foil layers on the surfaces of the supporting substrate at the peripheries of the metal foil layers with the metal foil layers, each metal foil layer being larger than the corresponding dummy metal layer; and
cutting the laminates and the supporting substrate at positions inside the peripheries of the dummy metal layers and separating the metal foil layers from the dummy metal layer to detach the laminate from the supporting substrate.
